(19) United States
(12) Patent Application Publication
(10) Pub. No.: US 2025/0205970 A1
(43) Pub. Date: Jun. 26, 2025

(54) Device for Feeding Plastic Material in the Form of Filaments During Material-Adding Manufacturing of Three-Dimensional Objects

(71) Applicant: Kenneth SKOGWARD, Huskvarna (SE)

(72) Inventor: Kenneth SKOGWARD, Huskvarna (SE)

(21) Appl. No.: 18/849,567

(22) PCT Filed: Mar. 22, 2023
(86) PCT No.: PCT/SE2023/050255

§ 371 Date: Sep. 23, 2024

(30) Foreign Application Priority Data
Mar. 22, 2022 (SE) 2230087-5

(51) Int. Cl. B29C 64/321; B29C 64/118; B29C 64/241; B33Y 30/00; B33Y 40/00

(52) U.S. Cl. CPC B29C 64/321; B29C 64/241; B33Y 40/00; B29C 64/118; B33Y 30/00

(57) ABSTRACT

Device for feeding plastic material in the form of filaments (3) at material additive manufacturing of three-dimensional objects by melting the fed filament and discharging the melted material through a nozzle. The material is dispensed on a construction platform during the movement of the nozzle relative to the construction platform with controlled movements in three dimensions according to a selected pattern. Two wheels (11, 12) are rotatably mounted for opposite rotation about their axes (13, 14) in a holder (10) and form between them a passage for the filament between the circumferences of the wheels. One wheel is a motor-driven feed wheel. This is provided with teeth (16), which are distributed over its circumference. A closed guide channel (17) extends through the passage relative to the feed wheel, which engages the filament with its teeth during its rotation and feeds the filament in its longitudinal direction through the guide channel. This has a transverse dimension adapted to guide the filament, limited by an enclosing channel wall in the guide channel. The feed wheel (11) has a width that is less than or equal to the transverse dimension of the guide channel. The guide channel has an elongated cut-out with a width that falls below the transverse dimension of the guide channel.

### REFERENCE TO RELATED APPLICATIONS

This application is a U.S. national stage entry from International (PCT) application PCT/SE2023/050255, filed 22 Mar. 2023, which in turn claimed priority of Swedish patent application 2230087-5, filed 22 Mar. 2022.

### TECHNICAL FIELD

The present invention relates to a device for feeding plastic material in the form of filaments during material-adding manufacturing of three-dimensional objects.

### BACKGROUND ART

Devices for the additive manufacturing of three-dimensional objects, so-called 3D printers, require great accuracy when feeding the filament, a thread-like material, in order to obtain a good final product in the form of a three-dimensional object. Feeding devices usually feed the filament to the print head by clamping the filament between a gear wheel and a roller such that the teeth of the gear wheel can engage the filament, such that the rotating gear wheel transfers a rotary motion to a linear motion of the filament. In the current type of production, the filament material is any suitable thermoplastic, polymer, which is fully or partially meltable by heating, for example the thermoplastics PLA, PETG, PA, ABS, etc. and TPU. The filament acts as a piston, which pushes the filament material through a heating chamber such that it can be discharged through the nozzle and form a strip that fuses to the base. The first layer is dispensed on a building plate where the strip attaches in such a way that the detail can be removed when it is finished. The subsequent layers of the strip merge with the previously dispensed strip layers to form a three-dimensional detail. In order to define the width of the strip that provides a large part of the accuracy of the printed object, a very accurate feeding of the filament is required.

The feed wheel is often directly attached to the drive motor shaft, but it also happens that the feed wheel is driven by a gear between the drive motor and the feed wheel to obtain greater accuracy and greater driving force.

As mentioned above, the filament is clamped against the feed wheel by means of a roller on the opposite side of the filament, whereby the roller is attached to a link and on the other side of the link there is a spring. The link whose levers have different lengths means that the spring force is switched such that the clamping force further increases against the feed wheel to enable that the teeth of the feed wheel engage well in the filament. In known feeding devices, the feed wheel and roller have a width that significantly exceeds the filament, which makes it difficult to guide the filament in the area around the feed wheel. To remedy this, one tries to let the channel that guides the filament run as close to the feed wheel and roller as possible. In the space where the feed wheel and the roller are closest, it is so cramped that there is an extremely small surface that can guide the filament laterally, see U.S. Pat. No. 10,926,527 B2. Since the guidance of the filament is not good in the area around the feed wheel and roller, it is often difficult to load the filament into the feeder.

### SUMMARY OF THE INVENTION

It is therefore an aim of the present invention to solve the above-mentioned problem by providing a device according to the present invention, the characteristics of which appear in patent claim 1.

By means of the invention, a significantly improved guidance of the filament through the feeding device is achieved and the loading of new filaments is facilitated.

### BRIEF DESCRIPTION OF THE DRAWINGS

In the following, the invention will be described in more detail with various embodiment examples with reference to attached drawings, on which

FIG. 1 shows a type of printer head belonging to a 3D printer, the printer head having a feeding device and a relatively rigid guide tube for the fed filament,

FIG. 2 is a perspective view of the print head according to FIG. 1,

FIG. 3 is a section through an enlarged detail of FIG. 1 showing a fed filament formed into a strip and dispensed on a plate;

FIG. 4 is a perspective view of another type of print head, where the guide tube is flexible, the feeding device being omitted from the figure,

FIG. 5 is a perspective view of the feeding device in a first embodiment example,

FIG. 6 is a side view of the feeding device according to FIG. 5,

FIG. 7 is a section along the line A-A in FIG. 6,

FIG. 8 is an enlarged partial view B of the section in FIG. 7,

FIG. 9 is an end view of the feeding device,

FIG. 10 is a section through the feeding device in an engaged feed position along the line C-C in FIG. 9,

FIG. 11 is an enlarged partial view D of the feeding device of FIG. 10,

FIG. 12 is a section through the feeding device along the line E-E in FIG. 10,

FIG. 13 is an enlarged partial view F of FIG. 12,

FIG. 14 is a section corresponding to FIG. 10, but shows the feeding device in a disconnected position,

FIG. 15 is a perspective view of the feeding device in a second embodiment,

FIG. 16 is a side view of the feeding device according to FIG. 15,

FIG. 17 is a section through the feeding device along the line A-A in FIG. 16 and

FIG. 18 is an enlarged partial view B of the sectional view according to FIG. 17.

### DETAILED DESCRIPTION

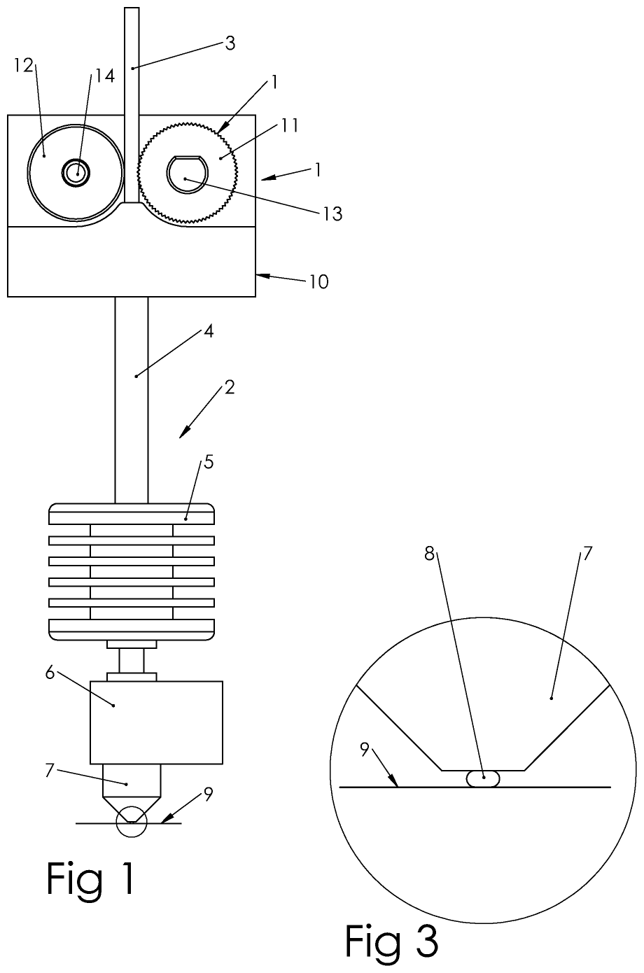

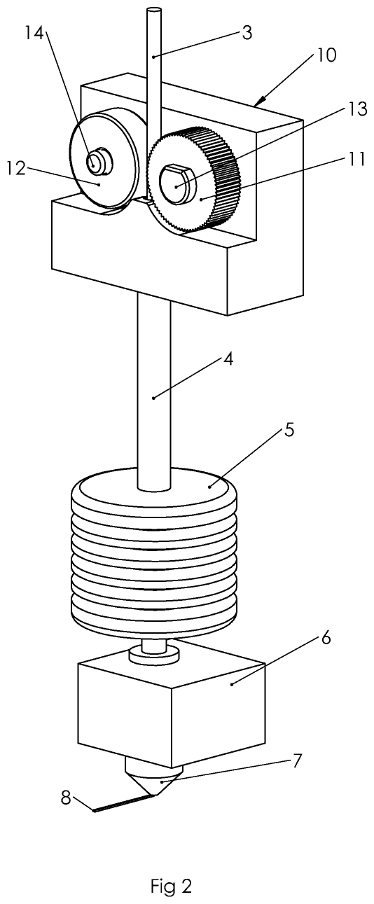

The feeding device 1 according to the invention is included in a printer head 2, see FIGS. 1 and 2, which is intended to be included as part of a type of 3D printer, which may otherwise have a known structure and is therefore not described and shown in more detail. 3D printers of the current type are intended to produce three-dimensional objects from a polymer of a thermoplastic type by feeding a thermoplastic string, commonly called filament, melting the string and dispensing the string as an strip according to a selected pattern on a platform. The pattern, i.e. the three-dimensional shape, is created after a programmed three-dimensional control of the printer head and the platform for movements relative to each other in three dimensions or directions, referred to below as x-, y-, z-directions, which represent mutually perpendicular axes in an imaginary coordinate system. The 3D printer essentially consists of a stand, which supports the printer head for movements by means of motor-driven transmissions in a plane, i.e. in two dimensions or x-, y-directions, while the platform is movably supported for motor-driven movements from or towards this plane, in a third dimension or direction, z-direction. Alternatively, the platform can be stationary, while the print head is movable in all three directions. The control of the movements of the printer head and the feeding movements of the feeding device take place by means of control signals from an electronic control unit, which is programmed starting usually from a CNC code which is, for example, created from a digital three-dimensional object in a CAD program.

The printer head 2 is, as shown schematically in FIGS. 1 and 2, essentially composed of the feeding device 1 for the string, hereinafter referred to as the filament 3, a guide tube 4 for the filament, a cooler 5 for the filament, and a heating chamber 6 for heating the filament to melting and a nozzle 7 for dispensing the molten filament in the form of an strip 8 on the platform 9, which is best seen in the enlarged partial view in FIG. 3. In the example shown, the entire print head, including the feeding device 1, is mounted on a carriage, mounted on the stand for synchronous movements in the x-y direction, relative to the stand, while the filament 3 runs from a magazine in the form of a filament roll, which is suitably rotatably attached to the stand. However, for the sake of clarity, the stand, carriage and filament roll are not shown. In FIG. 1, a holder 10 is shown, which is supported by the carriage and is part of the feeding device. The holder 10 is described and shown in detail below.

Counter-rotating wheels or rollers are rotatably mounted in the holder 10. In the example there are two wheels, one of which is a feed wheel 11 and the other of which is a counter wheel, hereinafter referred to as an idler roller 12, both of whose turning axles 13, 14 are indicated in FIGS. 1 and 2. The holder further supports a drive mechanism for the feed wheel 11 in the feeding device 1. The drive mechanism consists of a drive motor, preferably an electric stepper motor, whose output shaft is connected directly or via a gear transmission to the shaft 13 of the feed wheel 11, which thus constitutes its drive shaft. The output shaft is set up to turn predetermined parts of a revolution in one or the other direction of rotation depending on control signals to the stepper motor from the control unit. The drive mechanism is omitted from the figures for the sake of clarity. In the example, the idler roller 12 is free-running, i.e. not directly driven, and is thus counter-rotating, i.e. has the opposite direction of rotation to the feed wheel 11, and is in contact with the filament 3 at its circumference and thus follows its own movements and the movements of the feed wheel 11. The idler roller 12 is either rotated by bearing around its axle 14, which is thus fixed in the holder, or the axle is carried along and is mounted in a bearing in the holder.

The feed wheel 11 is provided with a large number of teeth 16, which in the example extend over the entire width of the feed wheel. The teeth 16 are adapted to engage the filament 3 in order to press it through the guide tube 4 towards the cooler 5, the heating chamber 6 and the nozzle 7 by means of the pressure of the feed wheel with its periphery against the filament 3 with the idler roller 12 as a rotating counteracting force. More specifically, the filament runs through the feeding device via a passage with a carefully adapted width in the form of a guide channel 17 in the gap between the feed wheel 11 and the idler roller 12. The guide channel 17 has a main tangential direction through the gap relative the mainly circular periphery of the feed wheel 11 and the idler roller 12. The characteristic extension and design of the guide channel 17 in the space between the feed wheel 11 and the idler roller 12 are not shown in FIG. 1, but is described in more detail below with reference to FIG. 8 onwards.

In the type of assembly shown in FIG. 1, the entire printer head 2 with the feeding device 1, the guide tube 4, the cooler 5 and the nozzle 6 is supported on the carriage and follows its controlled movements, meaning that the feeding device 1 has an unchanged distance to the cooler during operation, whereby the guide tube 4 can be relatively stiff.

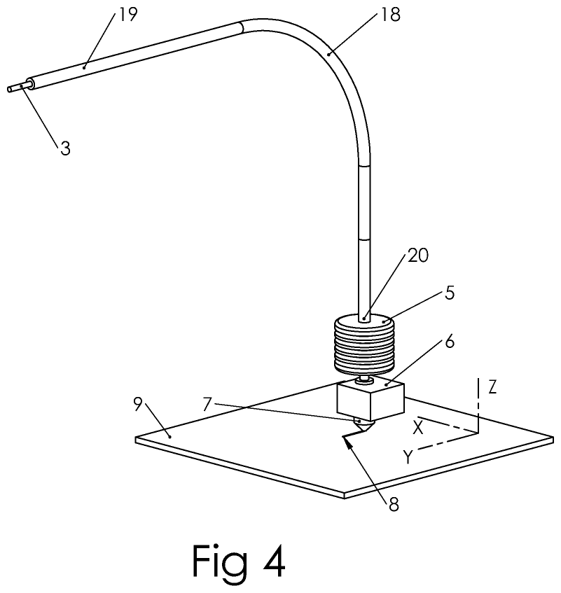

FIG. 4 shows a flexible, i.e. pliable guide tube 18, commonly called a Bowden cable, which is useful in an alternative type of assembly, where the feeding device is supported stationary in the stand and the rest of the printer head, i.e. the cooler 5, the heating chamber 6 and the nozzle 7 are supported by the carriage. The positions of and the distance between both ends 19, 20 of the guide tube 18 can then be changed as required during operation. As will be described in more detail below, in practice the flexible guide tube, at least at its end 19, passes towards the feeding device 1 in a less flexible or relatively rigid part, which forms part of the guide channel 17 for the filament and extends into the gap or passage, where the guide channel according to the invention is given a special design, which is described in more detail below. In FIG. 4, the above-mentioned coordinate system is also inserted with its x-, y- and z-axes.

The holder 10 is made up of two frame parts 21, 22 that are moveable with a controlled movement relative to each other, where one frame part 21 supports the feed wheel 11 and the other frame part 22 supports said counter wheel 12 and the guide channel 17. This controlled movement partly enables a switch of the feeding device between engagement position or feed mode and disengaged mode and partly an adjustment of the feed wheel 11 engagement depth. To enable these functions, a switching device and an adjustment device are therefore included, which can be separate or combined with each other, as described in more detail below with an example.

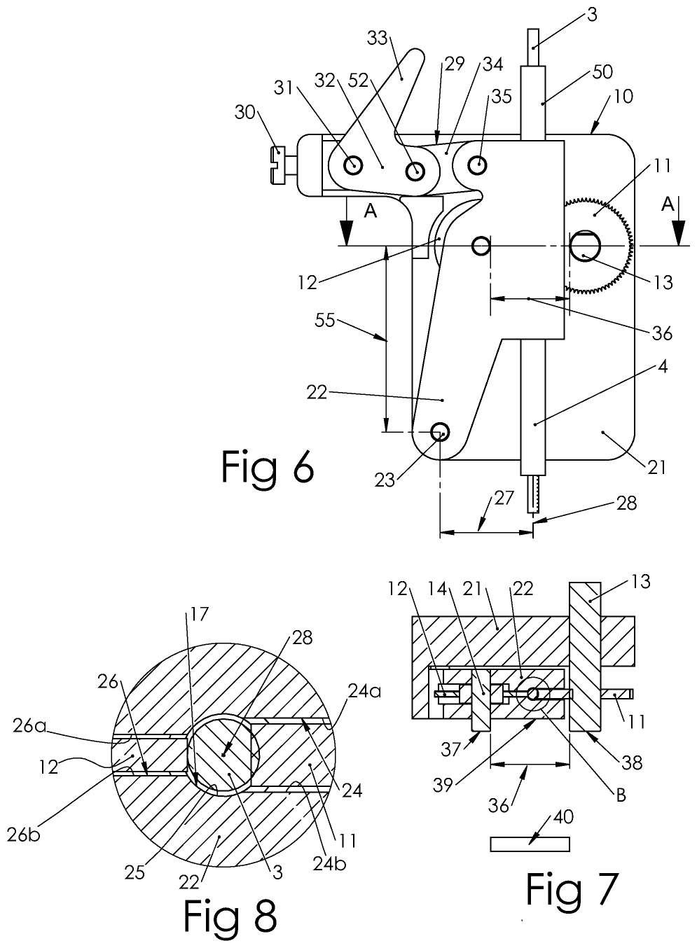

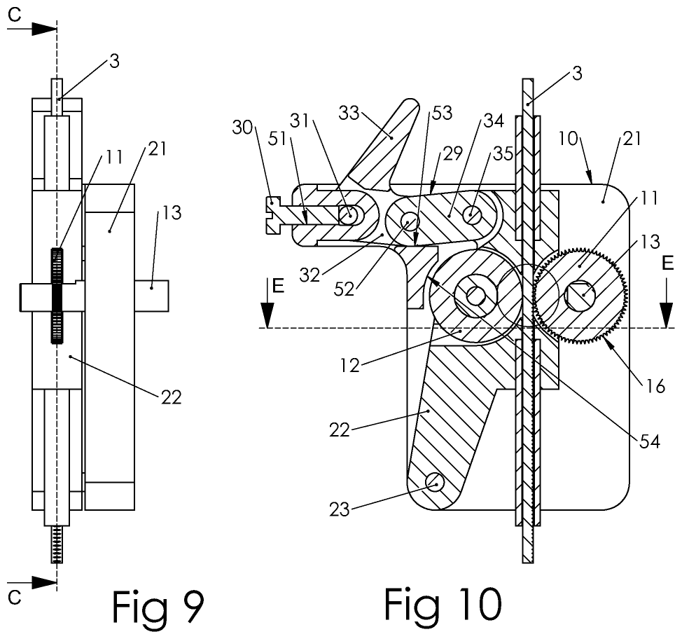

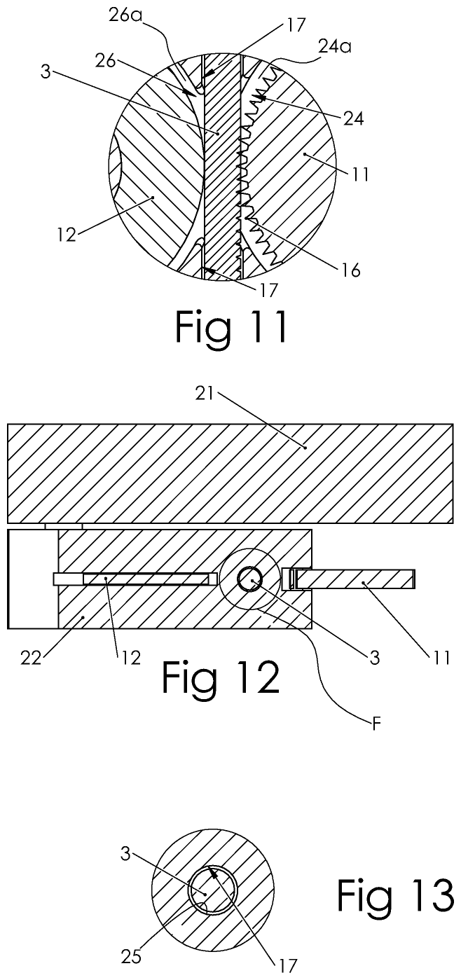

The structure of the holder 10 shall be described in more detail with reference to FIGS. 6 to 14, which show a first embodiment. In order to bring about the movements of the two frame parts 21, 22 relative to each other, one frame part 21 of the holder 10 is in this example pivotally connected to a link arm which constitutes the other frame part 22. The pivotability is obtained by means of a first pivot axle 23, also called the main pivot axle. The holder 10 is supported by either the movable carriage or the fixed stand in the 3D printer, depending on whether its structure is of the type shown in FIG. 1 or FIG. 4. This means that either the frame part 21 or the link arm 22 can be fixedly attached to the carriage or the stand, while the other part is pivotably movable relative to the fixed part around the main pivot axle 23. In the frame part 21, the feed wheel 11 is rotatably supported by means of its axle 13, while the idler roller 12 is rotatably mounted in a bearing in the link arm 22 by means of its shaft 14. The feed wheel 11 is driven by a drive motor via its shaft 13 either directly or via a transmission. The feed wheel 11 and the idler roller are advantageously axially free-running, i.e. axially movable, within certain end positions.

In the holder 10, the main pivot axle 23 of the link arm 22 is parallel to the axle 13 of the feed wheel 11 and enables the link arm to be pivoted towards or away from the feed wheel. The above-mentioned guide channel 17 which runs perpendicular to the axle of the feed wheel 13, where the guide channel has a cut-out 24 for the feed wheel 11 in the channel wall 25 of the guide channel, see FIG. 8. The cut-out 24 is formed as an, elongated narrow slit in the channel wall 25 in the longitudinal direction of the guide channel 17, and extends through the goods of the solid link arm 22 in the example, viewed transversely to the longitudinal direction of the guide channel, and is open outwards towards the feed wheel 11. It is in the example cylindrical, more specifically has the shape of a circle segment with a center of curvature, which is concentric with the axle of the feed wheel 13 with a slightly greater radius of curvature than the radius of the feed wheel, see FIGS. 10, 11 and 14, such that the feed wheel can push into the guide channel 17 with its toothed periphery to grip the filament 3 with its teeth 16. The imaginary axis of the center of curvature for the cut-out 24 extends perpendicular to the longitudinal direction of the guide channel 28.

The section in FIG. 8 shows the important feature that the width of the feed wheel 11, viewed in the axial direction of the wheel, is less than the transverse dimension, i.e. diameter, of the guide channel 17, and thus the transverse dimension, i.e. diameter, of the filament 3. The width can be up to equal to the lateral dimension or diameter of the guide channel. In this way, the cut-out 24 can be made narrow, only slightly wider than the feed wheel 11, which provides stabilizing guidance with the help of the cut-out's mutually facing edge surfaces 24a, 24b, which form guide surfaces for the feed wheel 11. This is thus movable in an axial direction between the edge surfaces 24a, 24b, which constitute end positions for the axial mobility. The guide channel 17 thereby becomes maximally enveloping around the filament, which obtains optimal guidance in the passage through the feeding device. The idler roller 12 is directly attached to the link arm 22 such that it projects with its circular periphery slightly into the guide channel 17 through a corresponding cut-out 26 from the opposite side of the channel, where the feed wheel 11 projects into the guide channel 17. The cut-out 26 for the idler roller 12 also has mutually facing edge surfaces 26a, 26b, which form axial constraints for the idler roller, which, like the feed wheel, can be axially movable between the edge surfaces. The idler roller 12 protrudes by a fixed measure and has a fixed distance to the center line 28 of the channel relative to the axis of rotation of its axle 14, such that the filament is guided such that the center line 28 of the guide channel coincides with the center line of the filament. The guide channel 17 on the feeding device's input side for the filament 3 can have a different form, for example be funnel-shaped, or, as in the example shown, have an additional guide pipe piece 50, which connects to the guide channel 17 in the link arm 22. Correspondingly, on the feeding device's output side, the steering pipe 4 is firmly mounted to the link arm 22 on the holder 1 and connects to the steering channel.

At a distance from the main pivot axle or first pivot axle 23, there is a second pivot axle 35, hereinafter referred to as the connection pivot axle, which is parallel to the main pivot axle and is connected to a link system 29, which, through overcenter function, can be switched between two stable positions, an engagement position, in which the feed wheel 11 is engaged with the filament and a disengagement position in which the feed wheel is retracted from this engagement. The link system also includes an adjustment screw 30 to adjust the engagement depth of the feed wheel in the filament in the engaged position. The adjustment screw 30 is screwed into a threaded bore 51 in the frame part 21 and can be adjusted in its longitudinal direction. The adjustment screw 30 cooperates with a third pivot axle 31, hereinafter referred to as the operating pivot axle, which is designed as a shaft pin on an operating link 32, see FIG. 10. This is provided with a manually adjustable switching lever 33 that can be pivoted between the engagement and disconnected positions around the operating pivot axle 31. The operating link 32 is via a fourth pivot-axle 52, hereinafter referred to as a common pivot-axle, articulatedly connected to a connecting link 34 and is via the connecting pivot-axle 35 connected to the link arm 22 for the adjustment movement between the two positions by pivoting around the main pivot axle 23.

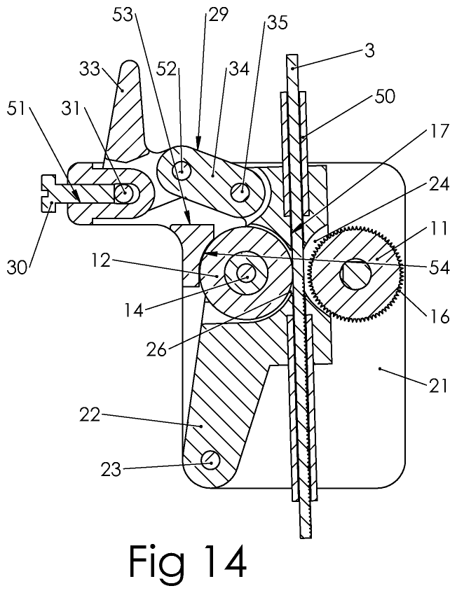

The engagement position of the feeding device 1 is evident from the section in FIG. 10, while the disengagement position is evident from the section in FIG. 14. The overcenter movement of the link system has two end positions, defined by two stops 53, 54. One stop 53 forms an end stop for the other link 34 in the engagement position, while the second stop 54 forms an end stop for the idler roller 12 in its pivoting movement on the link arm 22. The end stop occurs when the periphery of the idler roller makes contact with the stop. The overcenter function is obtained by the link system 29 being slightly tensioned, when the teeth 16 of the gear wheel 11 are pressed into the filament 3. The direction of the torque on this second link 34 is caused to shift, when the common pivot axle 52 goes “over center”, i.e. passes the connecting line between the connecting pivot axle 35 and the operating pivot axle 31. The switch thus takes place with a manual force action with finger contact with the switch lever 33 for counter-clockwise movement around the operating pivot axle 31 from the engagement position, as shown in FIGS. 6 and 10 to the disengagement position, as shown in FIG. 14. The reverse switching movement from the disengagement position to the engagement position takes place in the corresponding way with manual force action, but clockwise.

The engagement position can be set to different engagement depths in the filament by means of the adjustment screw 30 such that a constant predetermined engagement of the feed wheel 11 is obtained throughout the printing of 3D objects. The described link system 29 and the adjustment screw 30 thus constitute a combined adjustment device for the depth of engagement and switching device for switching the feeding device between engaged position and disengaged position. By the fact that the feed wheel 11 is supported by the frame part 21 and the guide channel 17 is supported by the pivotable link arm 22, the adjustment of the engagement depth and the switching between engagement position and disconnected position is thus done by a pivoting movement of the link arm relative to the frame part, whereby the feed wheel 11 is switched between different insertion depths in the guide channel through the elongated cut-out. This relative movement of the link arm 22 occurs both in the case where the frame part 21 of the holder 10 is fixedly mounted on the carriage, and in the case where the link arm is fixedly mounted, whereby the pivoting movement takes place at the frame part.

Different filament materials may require different depths of engagement. The depth of engagement is directly proportional to the distance 36 between the axes 13, 14 of the feed wheel 11 and the counter roller 12, i.e. a certain distance 36, see FIG. 7, between the axes corresponds to a certain depth of engagement. Based on experience, it is possible to create standard settings for different filament materials/engagement depths. This has here been solved by providing the shafts 13, 14 of the feed wheel 11 and the counter roller 12 with end parts 37, 38, which protrude outside the flat outer side 39 of the link arm 22, whereby measurement can be carried out directly between the projecting end parts, which form opposite measuring reference surfaces. In the example, this has been facilitated by the system including a number of measuring means 40 of different lengths, one of which is shown in FIG. 7.

During operation, the feeding device 1 is exposed to varying forces depending on a varying feed resistance that occurs in the filament. This is particularly obvious when using a flexible guide tube between the feeding device 1 and the cooling chamber 5, for example in the form of a Bowden cable 18, as shown in FIG. 4, whereby these forces create a varying torque on the holder 10 around the pivot axle 23 of the link arm 22 with a lever arm 27, which is indicated in FIG. 6. By means of the holder's structure, the torque creates an increased engagement pressure of the feed wheel on the filament and an increased engagement depth at higher feed resistance. The transmission of this torque can be controlled by choosing the ratio between the lever arm 27 and the lever arm 55 between the pivot axle 23 and the axles 13, 14 of the idler roller 12 and the feed wheel 11. In the shown structure of the holder, this movement is geared up, because the placement of the feed wheel 11 and the idler roller 12 shafts 13, 14 creates a longer lever arm 55 than the lever arm 27, which is indicated in FIG. 6. The changed relative movement between the frame part 21 and the link arm 22, due to the varying feed resistance, is made possible by a certain flexibility in the link system 29.

The solution with a link arm that contains a guide channel with minimal cut-outs for the feed system also solves the problem of loading the machine with new filament when it runs out or when you want to change filament. This is enabled by having an unbroken and an open channel in the disconnected position from the inlet before the feeder to the heating chamber and the nozzle, see FIG. 14.

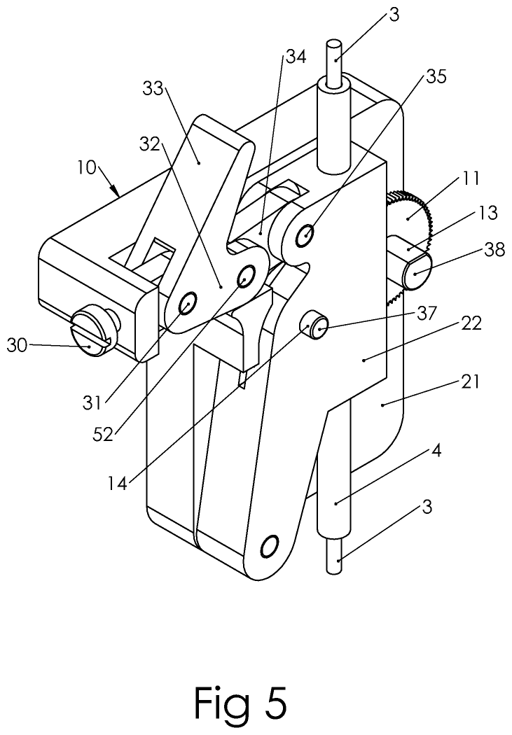

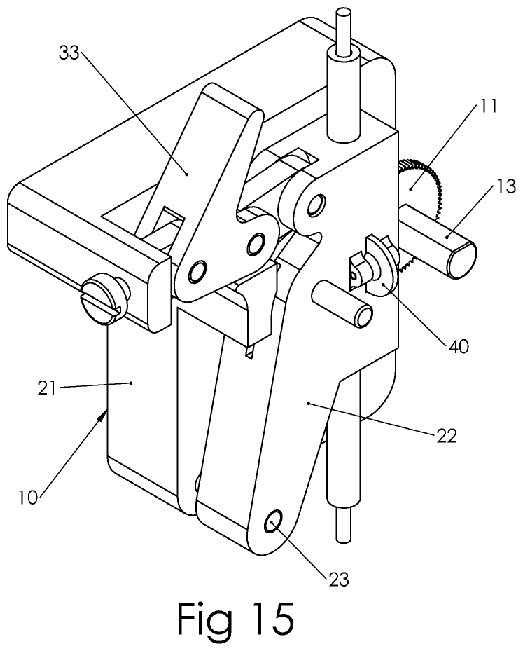

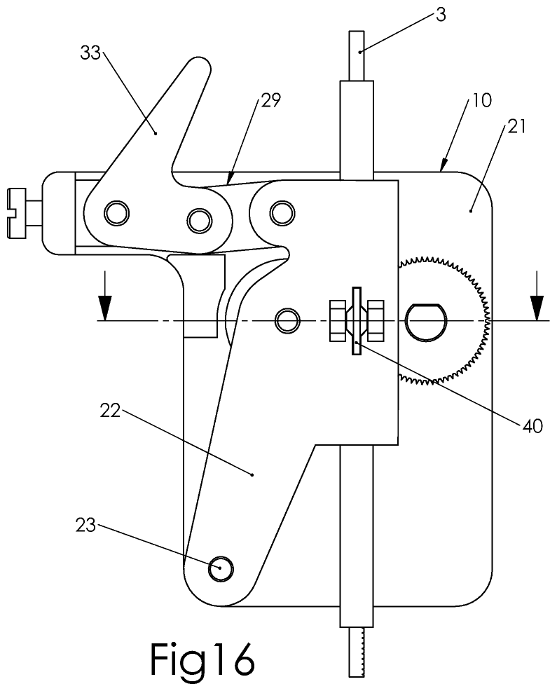

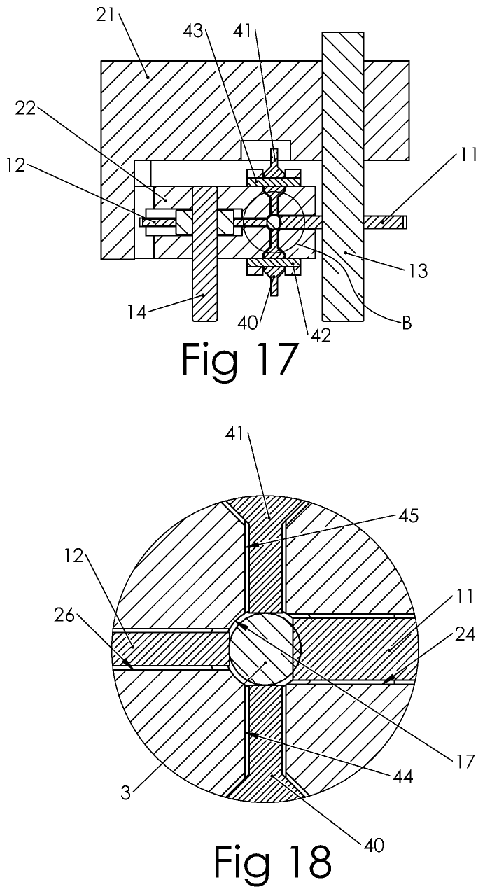

FIG. 15-18 show a second embodiment example of a feeding device 2 according to the invention, which has the same main structure and basic function as in the first example according to FIG. 5-14, and therefore mainly the parts and functions that are added in the second example are described here. Corresponding parts are here given the same reference numbers as in the first example. In this second example, the idler roller 12 has been supplemented with two further idler rollers 40, 41, which are opposite each other and, like the first idler roller 12, are free-running, i.e. not motor-driven, but co-running by contact with their periphery against the filament 13. The two idler rollers 40, 41 are rotatably mounted in a bearing by a corresponding axle 42, 43 and attached to the link arm 22. The axles 42, 43 extend perpendicular to the respective axles 13, 14 of the feed wheel 11 and the idler roller 12. In the example, these supplementary idler rollers 40, 41 have a significantly smaller diameter than the first idler 12, for example in the order of magnitude of half its diameter. As can best be seen from the cross-section in FIG. 18, cut-outs 44, 45 are arranged in the guide channel 17 also for these supplementary idler rollers 40, 41. Here it is also clear that all three idler rollers 12, 40, 41 have a relatively small width less than both the width and transverse dimension, respectively, of the feed wheel 11 and the guide channel 17. All cut-outs 24, 26, 44, 45 have a width that only slightly exceeds the width of the feed wheel 11 and the idler rollers 12, 40, 41, respectively. By means of support with roller contact and also a high degree of enclosing of the walls of the guide channel 17, a very good guidance of the filament 3 to the center of the guide channel is obtained, while feeding this by means of the feed wheel 11.

Having narrow feed wheels also opens up the possibility of putting more feed wheels with teeth on the same diametrical plane that is perpendicular to the longitudinal axis of the filament, for example the feeding device can consist of four feed wheels that are 90 degrees apart. One of the feed wheels is driven from the outside, similar to previously described examples, and the other wheels are driven internally via angle gears and between the drive wheels. In this way, a feed system is obtained where each feed wheel does not have to engage so deeply in the filament material and where the filament is guided to the center of the guide channel.

In the same way, three feed wheels can be arranged on a diametrical plane with an angle of 120 degrees between the feed wheels with one feed wheel driven from the outside and the other feed wheels are driven internally with angular gears. Even with this solution, the filament is centered in the guide channel, which also provides optimal guidance of the filament in the area around the feed wheels.

These two solutions do not need to have adjustable depth of engagement given that the engagement is shared by three or four feed wheels.

Another important function of the feeding device 2 is to reverse the filament. When the printer head 1 is to be transported from one printing area to another, the filament is reversed a small distance such that the pressure in the heating chamber 6 decreases to prevent a thin string of plastic between the printing areas. The filament 3 is then fed forward a short distance.

The invention is not limited to the examples described above and shown in the drawing. Alternatively, the idling counter roller shown can be replaced by a second, driven and opposed feed wheel, which can have the same design as the first feed wheel. It is conceivable that the adjustment of the engagement depth is made with a simpler adjustment device, for example without the switching function between engagement mode and disengagement mode.

1. A device for feeding plastic material in the form of filaments (3) for material additive manufacturing of three-dimensional objects comprising:
a nozzle through which the fed filament, in a melted state, is discharged and dispensed onto a construction platform (9) during the movement of the nozzle relative to the construction platform with controlled movements in three dimensions according to a selected pattern;
at least two wheels (11, 12), including at least one motor-driven feed wheel that has a controlled rotational movement and at least one counter-rotating wheel, that are counter-rotating around respective axles (13, 14), which are rotatably mounted in a bearing in a holder (10),
in which the feed wheel is provided with teeth (16), which are distributed about a periphery of the feed wheel,
a guide channel (17), formed within the holder, and extending in a mainly tangential direction relative to the periphery of the feed wheel (11) and the counter-rotating wheel (12),
in which:
the feed wheel is arranged to feed the filament in a longitudinal direction through the guide channel with its teeth by engaging the filament during rotation of the feed wheel,
the guide channel has a diameter that is adapted to guide the filament, limited by an enclosing wall (25) in the guide channel,
the feed wheel (11) has a width which, viewed in an axial direction of the feed wheel, is less than the diameter of the guide channel (17), viewed in the same direction,
a first cut-out (24) is arranged in the holder (10), which first cut-out is open towards the feed wheel and to the guide channel through a wall (25),
the cut-out is elongated, viewed in a longitudinal direction of the guide channel, and has a width that is less than the guide channel, viewed in the axial direction of the feed wheel, but is greater than the width of the feed wheel,
whereby the guide channel with its wall runs continuously through a gap between the at least two wheels, whereby the filament is continuously supported by the wall of the guide channel (25) through the gap and the feed wheel projects through the first cut-out into the guide channel and grips the filament (3) with its teeth (16) and is supported by edge surfaces (24a, 24b) of the first cut-out (24).

2. The device according to claim 1, characterized in that the second wheel comprises of an idler roller (12), which has a width that is less than a transverse dimension of the guide channel (17) and which projects into the guide channel through a second cut-out (26) in the wall of the guide channel for idling, counteracting abutment against the filament (3).

3. The device according to claim 1, characterized in that the first and second cut-outs (24, 26) have the shape of a circle segment and that an axial direction of each cut-out is substantially perpendicular to the longitudinal direction (28) of the guide channel (17).

4. The device according to claim 2, characterized in that the feed wheel (11) and the idler roller (12) are axially movable in their respective first and second cut-outs (24, 26) between end positions, which are formed by mutually facing respective edge surfaces (24a, 24b, 26a, 26b) in the first and second cut-out.

5. The device according to claim 2, wherein the holder (10) comprises two frame parts that move with a controlled movement relative to each other, of which a first frame part (21) supports the feed wheel (11) and a second frame part (22) supports the idler roller (12) and the guide channel (17).

6. The device according to claim 5, characterized in that the guide channel (17) is pivotally suspended in relation to the feed wheel (11) about a pivot axle (23), which is parallel to the axle of the feed wheel (13), such that the guide channel with the filament (3) can be brought towards the feed wheel such that it engages the filament.

7. The device according to claim 6, characterized in that the feed wheel (11) is rotatably mounted in the first frame part (21) with its axle (13), and that the second frame part (22) comprises a link arm pivoted around the pivot axle (23) that is connected to first frame part, and which supports the roller (12) and the guide channel (17).

8. The device according to claim 5, further comprising: a switching device for switching the feeding device between an engaged feeding position with the feed wheel (11) in engagement with the filament (3) in the guide channel (17) and a disengaged position in which the feed wheel is retracted from the guide channel.

9. Device according to claim 5, further comprising an adjustment device that connects and allows relative movement of the first and second frame parts for adjustment of an engagement depth of the feed wheel (11).

10. The device according to claim 9, characterized in that the adjustment device includes an adjustment element (30), in the first frame part (21) that is provided for moving the pivoting position of the link arm (22) around the pivot axle (23) and thereby for moving the guide channel (17) relative to and for adjusting the engagement depth of the feed wheel (11).

11. The device according to claim 10, further comprising a first measurement reference surface on the first frame part (21) and a second measurement reference surface on the link arm (22), said first and second measurement surfaces forming opposite reference surfaces for measuring the engagement depth.

12. The device according to claim 11, characterized in that respective end portions (37, 38) of the axles (13, 14) of the feed wheel (11) and the idler roller (12) project from the first frame part (21) and the link arm (22), respectively, and form said measurement reference surfaces for setting the engagement depth by measuring the distance of the gap between the respective end portions.

13. The device according claim 9, characterized in that the adjustment device (33, 29) is adapted for adjustment of the pivoting position of the link arm (22) relative to the first frame part (21) and thus the feed wheel (11) between an engagement position, in which the feed wheel projects into the guide channel (17), and a disengagement position, in which the feed wheel is retracted from the guide channel.

14. The device according to claim 7, characterized in that the connection between the first frame part (21) and the link arm (22) includes a link system (29) with a plurality of links pivotally connected to each other about a common pivot axle (52), wherein a first link constitutes an operating link (32), which, at one end, is pivotally connected to the frame part via an operating pivot axle (31), and a second link that forms a connection link (34), which at one end is pivotally connected to the link arm at a distance from the pivot axle of the link arm (23) via a connection pivot axle (35), wherein pivoting the first and second links causes a pivoting movement of the link arm and thus a relative movement between the guide channel (17) and the feed wheel (11).

15. The device according to claim 14, characterized in that the operating link (32) is provided with switching element (33) for switching the link system (29) and thus the link arm (22) between an engagement position of the feed wheel (11) and a disengagement position and that the two links are clamped, with the common pivot axle (52) passing the connecting line between the operating pivot axle (31) and the connecting pivot axle (35) during the adjustment movement, whereby the link system switches torque direction by means of overcenter function.
